(19) United States
(12) Patent Application Publication
(10) Pub. No.: US 2017/0171331 A1
(43) Pub. Date: Jun. 15, 2017

(54) Method and electronic device for pushing videos between different clients

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Xuan JI, Beijing (CN); Xin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,148

(22) Filed: Aug. 19, 2016

Related U.S. Application Data
(63) Continuation of application No. PCT/CN2016/089528, filed on Jul. 10, 2016.

(30) Foreign Application Priority Data
Dec. 14, 2015 (CN) 2015109229434

(51) Int. Cl. H04L 29/08; H04L 29/06

(52) U.S. Cl. CPC H04L 67/26; H04L 67/42; H04L 67/306

(57) ABSTRACT

In the field of pushing video, a method and electronic device for pushing a video between different clients are provided. The method for pushing a video includes: receiving an identifier of a to-be-pushed video and a to-be-pushed-to destination client and/or a client corresponding to a to-be-pushed-to destination account, where a source client that provides the identifier of the video is bound to the destination client, and/or a source account corresponding to the source client is bound to the destination account; and the identifier of the video is pushed to the destination client and/or the destination account. By means of embodiments of the present disclosure, a video can be pushed without depending on a network connection between clients, thereby improving flexibility of pushing video and enhancing user experience.

### CROSS-REFERENCE TO RELATED APPLICATIONS

The present disclosure is a continuation of PCT application No. PCT/CN2016/089528 submitted on Jul. 10, 2016. The present disclosure claims priority to Chinese Patent Application No. 201510922943.4, filed with the Chinese Patent Office on Dec. 14, 2015, which is incorporated herein by reference in its entirety.

### TECHNICAL FIELD

The present disclosure relates to the field of pushing video, and specifically to a method and electronic device for pushing a video between different clients.

### BACKGROUND

With the rapid development of electronic products, demands for pushing a video between users or different clients of users are also increasingly enhanced. Currently, a user basically sends a video to be recommended to other users and/or other clients directly through the network. For example, when a user wants to recommend a video for another user, the user needs to send the video to the other user through a network connected between the two.

In prior art, if a user wants to recommend a certain video, a network connection must be established between the user and other users, that is, the user needs to push a video to other users or other clients by a network established between users. That is, the pushing manner is based on data transmission between users. According to such a pushing manner, once a pushing user is not connected to other users through a network, information sharing between the user and other users or other clients cannot be implemented.

### SUMMARY

An objective of some embodiments of the present disclosure is to provide a method and electronic device for pushing a video between different clients, where the method does not depend on a network connection between the clients, thereby improving flexibility of pushing video and enhancing user experience.

In order to implement the foregoing objective, some embodiments of the present disclosure provide a method for pushing a video between different clients, where the method for pushing a video includes: receiving an identifier of a to-be-pushed video and a to-be-pushed-to destination client and/or a to-be-pushed-to destination account, where a source client that provides the identifier of the video is bound to the destination client, and/or a source account corresponding to the source client is bound to the destination account; and pushing the identifier of the video to the destination client and/or a client corresponding to the destination account.

Accordingly, an embodiment of the present disclosure further provides a non-volatile computer storage medium, which stores computer executable instructions, where the computer executable instructions are used to execute any of the foregoing method for pushing video between different clients of the present disclosure.

Accordingly, an embodiment of the disclosure further provides an electronic device, including: at least one processor; and a memory in communication connection with the at least one processor. The memory stores instructions that can be executed by the at least one processor, and the instructions are executed by the at least one processor, so that the at least one processor can execute any of the foregoing resource searching method of the disclosure.

Other features and advantages of some embodiments of the present disclosure will be described in detail in the Detailed Description part below.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation. In the drawings:

FIG. 1 is a flowchart of a method for pushing a video between different clients provided by an implementation manner of the present disclosure;

FIG. 2 is a flowchart of a method for pushing a video between different clients of an implementation manner of the present disclosure;

FIG. 3 is a structural block diagram of a system for pushing a video between different clients provided by another implementation manner of the present disclosure; and

FIG. 4 is a structural block diagram of a server provided by another implementation manner of the present disclosure.

FIG. 5 is a schematic structural diagram of hardware of an electronic device for executing a method for pushing a video between different clients provided by another implementation manner of the present disclosure.

Description of the reference numbers

| | | | |
|---|---|---|---|
| 10 | source client | 20 | destination client |
| 30 | server | | |
| 31 | receiving module | 32 | pushing module |

### DETAILED DESCRIPTION

Specific implementation manners of the present disclosure are described in detail below with reference to the accompanying drawings. It should be understood that the specific implementation manners described herein are merely used to describe and explain the present disclosure rather than limit the present disclosure.

FIG. 1 is a flowchart of a method for pushing a video between different clients according to an implementation manner of the present disclosure. As shown in FIG. 1, the method for pushing a video between different clients provided by this embodiment may include: in step 11, receiving an identifier of a to-be-pushed video and a to-be-pushed-to destination client and/or a client corresponding to a to-be-pushed-to destination account, where a source client that provides the identifier of the video is bound to the destination client, and/or a source account corresponding to the source client is bound to the destination account; and in step 12, pushing the identifier of the video to the destination client and/or the client corresponding to the destination account. In this way, a video can be pushed without depending on a network connection between clients, thereby improving flexibility of pushing a video and enhancing user experience.

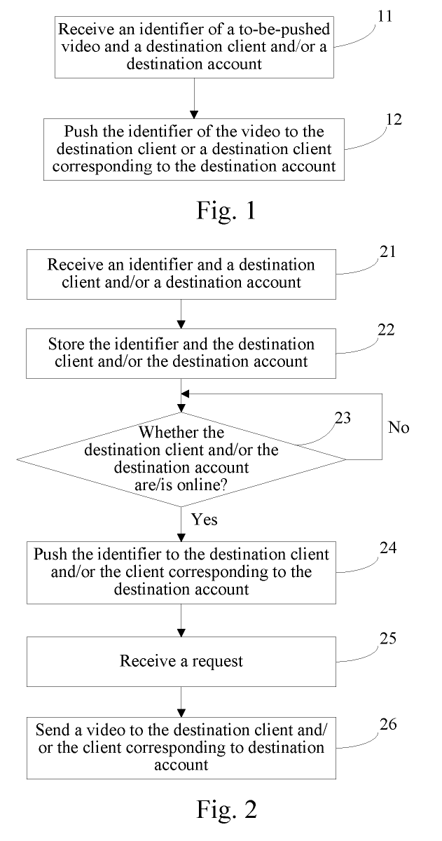

The method for pushing a video between different clients provided by some embodiments of the present disclosure is described below in detail by means of specific implementation manners by referring to FIG. 2. It should be understood that the implementation manner is merely illustrative and is not used to limit the present disclosure.

In this implementation manner, a client of a daughter may be bound to a client of parents. For example, the two are bound to the same account (for example, a family account), and certainly, the account may also be bound with other clients, for example, a client a, a client b, and the like. In addition, all clients that are bound to the family account may be listed in the family account, whenever a new client is bound to the family account, the new client may also be listed in the family account, and all the bound clients may be displayed on a client that logs into the family account.

When the family account is logged into by using the client of the daughter, and a video (for example, a historical video) possibly of the parents' interest is found, the client of the daughter may be used to select the historical video, select the client of the parents as a destination client of pushing, and send the identifier of the historical video and the to-be-pushed-to client of the parents to a server. The server receives the identifier of the historical video and the client of the parents as the destination client. That is, as described in FIG. 2, in step 21, a server receives an identifier of a to-be-pushed video and a to-be-pushed-to destination client and/or a client corresponding to to-be-pushed-to destination account. In step 22, the server may store the identifier of the to-be-pushed video and the to-be-pushed-to destination client and/or the to-be-pushed-to destination account, which, in the implementation manner, is storing the identifier of the historical video and the client of the parents. In step 23, whether the destination client and/or destination account are online is determined, i.e., determining whether the client of the parents are online. If the destination client and/or destination account are online, in step 24, the server pushes the identifier of the video to the destination client and/or the client corresponding to the destination account, i.e., pushing the identifier of the historical video to the client of the parents. At this time, the identifier of the historical video will be displayed on the client of the parents, and if the client of the parents wants to receive the historical video (for example, a user of the client of the parents clicks a confirmation key for receiving the historical video), the client of the parents may send a request for the identifier of the historical video to the server (requesting for obtaining the historical video), i.e., in step 25, the server receives a request for the identifier of the video from the destination client or the client corresponding to the destination account. In step 26, in response to the request, the server sends the video corresponding to the identifier of the video to the destination client and/or the client corresponding to destination account, i.e., in response to the request for the identifier of the historical video, sending the historical video to the client of the parents. In this way, pushing of the entire video is completed, and in addition, if not receiving the request, the server would not send the historical video to the client of the parents.

The identifier of the video may include a link of the to-be-pushed video.

In this embodiment, the identifier of the video may further include at least one of the following: a size of the video, a brief introduction, or view progress.

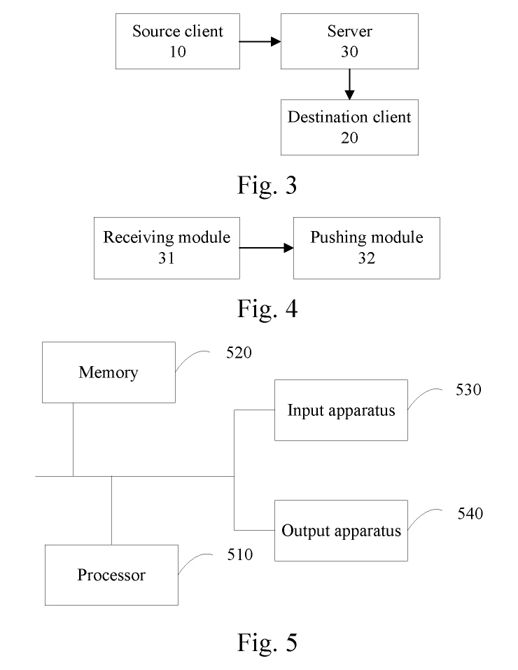

Correspondingly, some embodiments of the present disclosure further provide a system for pushing a video between different clients, and the system for pushing a video provided by some embodiments of the present disclosure are described below in detail by referring to FIG. 3 and FIG. 4.

FIG. 3 presents a structural block diagram of a system for pushing a video between different clients according to some embodiments of the present disclosure. As shown in FIG. 3, the system for pushing a video provided by this embodiment may include a source client 10, a destination client 20, and a server 30; the source client 10 is configured to send an identifier of a to-be-pushed video and the to-be-pushed-to destination client 20 and/or a destination account corresponding to the to-be-pushed-to destination client 20 to the server 30; and the destination client 20 is configured to receive the identifier of the video pushed by the server 30. In this way, a video can be pushed without depending on a network connection between clients, thereby improving flexibility of pushing a video and enhancing user experience.

In addition, the destination client 20 is further configured to send a request for the identifier of the video to the server 30; and the destination client 20 receives the video corresponding to the identifier of the video sent by the server 30 in response to the request.

FIG. 3 is a structural block diagram of a server according to the embodiments of the present disclosure. As shown in FIG. 3, the server 30 provided by this embodiment may include: a receiving module 31 configured to receive an identifier of a to-be-pushed video and a to-be-pushed-to destination client and/or a client corresponding to a to-be-pushed-to destination account, where a source client that provides the identifier of the video is bound to the destination client, and/or a source account corresponding to the source client is bound to the destination account; and a pushing module 32 configured to push the identifier of the video to the destination client and/or the client corresponding to the destination account.

Considering the desire of the users of the destination client and the destination account, the receiving module is further configured to receive a request for the identifier of the video from the destination client and/or the client corresponding to the destination account; and the pushing includes sending, in response to the request, the video corresponding to the identifier of the video to the destination client and/or the client corresponding to the destination account.

In addition, the server provided by this embodiment further includes a storage module configured to store the identifier of the to-be-pushed video and the to-be-pushed-to destination client and/or the to-be-pushed-to destination account.

When the destination client or the destination account are online, the pushing module pushes the identifier of the video to the destination client and/or the client corresponding to the destination account, for example, pushing the stored identifier of the video to the stored destination client and/or client corresponding to the destination account.

The identifier of the video may include a link of the to-be-pushed video.

In this embodiment, the identifier of the video may further include at least one of the following: a size of the video, a brief introduction, or view progress.

Another implementation manner of the disclosure provides a non-volatile computer storage medium, which stores computer executable instructions, where the computer executable instructions can execute the method for pushing a video between different clients in any of the foregoing method embodiments.

A schematic structural diagram of hardware of an electronic device for executing a method for pushing a video between different clients provided in another implementation manner of the disclosure, as shown in FIG. 5, the electronic device includes:

one or more processors 510 and a memory 520, with one processor 510 as an example in FIG. 5.

An electronic device for executing the method for pushing a video between different clients may further include: an input apparatus 530 and an output apparatus 540.

The processor 510, the memory 520, the input apparatus 530, and the output apparatus 540 can be connected by means of a bus or in other manners, with a connection by means of a bus as an example in FIG. 5.

As a non-volatile computer readable storage medium, the memory 520 can be used to store non-volatile software programs, non-volatile computer executable programs and modules, for example, program instructions/module corresponding to the method for pushing a video between different clients in the embodiments of the disclosure (for example, the receiving module 31 and the pushing module 32 shown in FIG. 4). The processor 510 executes various functional applications and data processing of the electronic device, that is, implements the method for pushing a video between different clients of the foregoing method embodiments, by running the non-volatile software programs, instructions, and modules stored in the memory 520.

The memory 520 may include a program storage area and a data storage area, where the program storage area may store an operating system and at least one application needed by function; the data storage area may store data created according to use of the electronic device, and the like. In addition, the memory 520 may include a high-speed random access memory, and also may include a non-volatile memory, such as at least one disk storage device, flash storage device, or other non-volatile solid-state storage devices. In some embodiments, the memory 520 optionally includes memories remotely disposed with respect to the processor 510, and the remote memories may be connected, via a network, to the electronic device. Examples of the foregoing network include but are not limited to: the Internet, an intranet, a local area network, a mobile communications network, and a combination thereof.

The input apparatus 530 can receive entered digit or character information, and generate key signal inputs relevant to user setting and functional control of the electronic device. The output apparatus 540 may include a display device, for example, a display screen, etc.

The one or more modules are stored in the memory 520, and execute the method for pushing a video between different clients in any of the foregoing method embodiments when being executed by the one or more processors 510.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A method for pushing a video between different clients applied to an electronic device, wherein the method for pushing a video comprises:
receiving an identifier of a to-be-pushed video and a to-be-pushed-to destination client and/or a to-be-pushed-to destination account, wherein a source client that provides the identifier of the video is bound to the destination client, and/or a source account corresponding to the source client is bound to the destination account; and
pushing the identifier of the video to the destination client and/or a client corresponding to the destination account.

2. The method for pushing a video according to claim 1, wherein the method for pushing a video further comprises:
receiving a request for the identifier of the video from the destination client and/or the client corresponding to the destination account; and
sending, in response to the request, the video corresponding to the identifier of the video to the destination client and/or the client corresponding to the destination account.

3. The method for pushing a video according to claim 1, wherein the method for pushing a video further comprises: storing the identifier of the to-be-pushed video and the to-be-pushed-to destination client and/or the client corresponding to the to-be-pushed-to destination account.

4. The method for pushing a video according to claim 1, wherein the method for pushing a video further comprises: when the destination client and/or the destination account are online, pushing the identifier of the video to the destination client and/or the client corresponding to the destination account.

5. The method for pushing a video according to claim 1, wherein the identifier of the video comprises a link of the to-be-pushed video.

6.-12. (canceled)

13. A non-volatile computer storage medium, which stores computer executable instructions that, when executed by an electronic device, cause the electronic device to:
receive an identifier of a to-be-pushed video and a to-be-pushed-to destination client and/or a to-be-pushed-to destination account, wherein a source client that provides the identifier of the video is bound to the destination client, and/or a source account corresponding to the source client is bound to the destination account; and
push the identifier of the video to the destination client and/or a client corresponding to the destination account.

14. The non-volatile computer storage medium according to claim 13, wherein the electronic device is further caused to:
receive a request for the identifier of the video from the destination client and/or the client corresponding to the destination account; and
send, in response to the request, the video corresponding to the identifier of the video to the destination client and/or the client corresponding to the destination account.

15. The non-volatile computer storage medium according to claim 13, wherein the computer executable instructions are further configured to store the identifier of the to-be-pushed video and the to-be-pushed-to destination client and/or the client corresponding to the to-be-pushed-to destination account.

16. The non-volatile computer storage medium according to claim 13, wherein the computer executable instructions are further configured to push the identifier of the video to the destination client and/or the client corresponding to the destination account when the destination client and/or the destination account are online.

17. The non-volatile computer storage medium according to claim 13, wherein the identifier of the video comprises a link of the to-be-pushed video.

18. An electronic device, comprising:
at least one processor; and
a memory communicably connected with the at least one processor for storing instructions executable by the at least one processor, wherein execution of the instructions by the at least one processor causes the at least one processor to:
receive an identifier of a to-be-pushed video and a to-be-pushed-to destination client and/or a to-be-pushed-to destination account, wherein a source client that provides the identifier of the video is bound to the destination client, and/or a source account corresponding to the source client is bound to the destination account; and
push the identifier of the video to the destination client and/or a client corresponding to the destination account.

19. The electronic device according to claim 18, wherein the at least one processor is further caused to:
receive a request for the identifier of the video from the destination client and/or the client corresponding to the destination account; and
send, in response to the request, the video corresponding to the identifier of the video to the destination client and/or the client corresponding to the destination account.

20. The electronic device according to claim 18, wherein the instructions are further set to execute: storing the identifier of the to-be-pushed video and the to-be-pushed-to destination client and/or the client corresponding to the to-be-pushed-to destination account.

21. The electronic device according to claim 18, wherein the instructions are further set to execute: when the destination client and/or the destination account are/is online, pushing the identifier of the video to the destination client and/or the client corresponding to the destination account.

22. The electronic device according to claim 18, wherein the identifier of the video comprises a link of the to-be-pushed video.
